(19) United States
(12) Patent Application Publication
(10) Pub. No.: US 2009/0269817 A1
(43) Pub. Date: Oct. 29, 2009

(54) PRETREATMENT OF GRAIN SLURRY WITH ALPHA-AMYLASE AND A HEMICELLULASE BLEND PRIOR TO LIQUEFACTION

(75) Inventor: Oreste J. Lantero, Trimble, MO (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: ICM, Inc., Colwich, KS (US)

(21) Appl. No.: 12/432,101

(22) Filed: Apr. 29, 2009

Related U.S. Application Data
(60) Provisional application No. 61/048,829, filed on Apr. 29, 2008.

(51) Int. Cl. C12C 1/00

(52) U.S. Cl. 435/93

(57) ABSTRACT

A method of preparing a low viscosity slurry that includes grinding a small grain to produce a flour. The flour is mixed with water to form a slurry. An alpha-amylase enzyme and a hemicellulase blend enzyme are mixed into the slurry and allowed to convert the slurry into a mash. A saccharifying enzyme is mixed into the mash. It is possible to use coarse grains such as grain sorghum and maize in conjunction with the small grains.

### REFERENCE TO RELATED APPLICATION

This application claims priority to U.S. Provisional Application No. 61/048,829, which was filed on Apr. 29, 2008, the contents of which are incorporated herein by reference.

### FIELD OF THE INVENTION

The invention relates generally to a method of processing grains. More particularly, the invention relates to a method of treating grain slurry with alpha-amylase and a mixture of Non-Starch Polysaccharide (NSP) hydrolyzing enzymes comprised of hemicellulase, cellulase and beta-glucanase enzymes prior to liquefaction.

### BACKGROUND OF THE INVENTION

With the increased demand for fuels and the limited availability of such fuels, there is an increasing desire to produce fuels from other materials. One such alternate fuel is ethanol, which is produced from grains such as corn.

In a typical dry mill corn ethanol plant, the ground corn is generally mixed with water to provide a slurry having a dissolved solids content of about 30 percent. The pH of the slurry is then adjusted to about 5.8. Approximately 40-50 percent of alpha-amylase enzyme is added to the slurry.

The temperature of the slurry is adjusted to about 80-85° C. with a residence time of 30-60 minutes. Next, the slurry is subjected to jet cooking at a temperature of between about 105° C. and 107° C. for about five minutes.

The liquefact is then flashed to liquefaction tanks and held for between about 1 and 1½ hours at a temperature of about 85° C. During the flash cooling, the remainder of the alpha-amylase is added to complete the liquefaction process.

Currently, a large portion of the commercial ethanol production uses corn. Because factors such as climate and local agronomic practices make certain regions of the world not suitable for optimal corn production and locally grown feedstocks are preferred sources of supply, there is a desire to use other feed materials for producing ethanol.

With mashes made from coarse grains such as corn and grain sorghums, alpha-amylase generally is the only enzyme required to sufficiently reduce the viscosity of the mash, and to hydrolyze the liquefied starch to prevent retrogradation upon cooling the mash for fermentation.

Attempts have been made to use ground small grains such as wheat instead of corn. When ground wheat is mixed with water to form a slurry, non-starch polysaccharides in wheat cause the slurry to have a high viscosity, which cause problems during the mashing process.

The conventional alpha-amylases added in typical corn and grain sorghum mashes do not hydrolyze the non-starch polysaccharides. As a result, the viscosity of the wheat slurry remains high during the liquefaction process. These features have heretofore limited the ability to use wheat in the production of ethanol.

### SUMMARY OF THE INVENTION

An embodiment of the invention is directed to a method of pretreating grain slurry with alpha-amylase, and a hemicellulase blend that contains a mixture of hemicellulase, xylanase, cellulase and beta-glucanse prior to liquefaction. The method thereby enables small grains such as wheat to be used in ethanol production. It is possible to use coarse grains such as grain sorghum and maize in conjunction with the small grains.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a chart of barley fermentation with NSP hydrolyzing enzyme used during processing.

FIG. 2 is a chart of barley fermentation without NSP hydrolyzing enzyme used during processing.

FIG. 3 is a chart of triticale fermentation without NSP hydrolyzing enzyme used during processing.

FIG. 4 is a chart of triticale fermentation with NSP hydrolyzing enzyme used during processing.

FIG. 5 is a chart of ethanol yield for barley and triticale.

### DETAILED DESCRIPTION OF THE PREFERRED EMBODIMENTS

An embodiment of the invention relates to the use of a combination of enzymes to reduce the viscosity of slurries prepared from small grains such as wheat, barley, rye and triticale as well as sweet potatoes and cassava. In particular, it has been found that using an alpha-amylase enzyme and a hemicellulase enzyme blend in conjunction with the endogenous beta-amylase hydrolyzes more starch during the preliquefaction step.

While the description and examples set forth herein are primarily related to the use of small grains, it is possible to use coarse grains in conjunction with the small grains. The coarse grains may be use in whole or fractionated forms. Examples of coarse grains that may be utilized in practicing this invention include grain sorghums, maize and combinations thereof.

As an initial step in the process of this invention, the grain may be ground. An example of a suitable grinding technique is a hammer mill. Grinding may utilize a screen having a variety of hole diameters with the most common diameter range containing, but not limited to, 2/64, 3/64, 4/64, 5/64, 6/64, 7/64 or 8/64 inch screen size.

Next, a slurry is prepared by mixing the ground grain with water. The slurry may have a dissolved solids content of up to 50 percent, depending on the grain that is utilized. In certain embodiments, the solids content of the slurry is between about 20 percent and 50 percent. When wheat is used in the slurry, the solids content may be about 30 percent.

It is also possible to adjust the pH of the slurry to increase the efficiency of the liquefaction process. The pH may be adjusted to between about 5.0 and 6.0. In one configuration, the pH is adjusted to approximately 5.5 using dilute sulfuric acid.

Enzymes are then added to the slurry. One such enzyme is alpha-amylase. In certain embodiments, the alpha-amylase is a bacterial thermal stable alpha-amylase. A person of ordinary skill in the art will appreciate that there are a variety of commercially available alpha-amylase enzymes that may be used. The alpha-amylase enzyme may be added at a concentration of up to 1.0 kg/MT and preferably between about 0.1 kg/MT and 0.2 kg/MT.

Another enzyme utilized in conjunction with the method of this invention is a non-starch polysaccharide (NSP) hydrolyzing enzyme. In certain embodiments, the non-starch polysaccharide hydrolyzing enzyme is a mixture of hemicellulases, xylanases, cellulases and beta-glucanases, which do not form maltose upon hydrolyzing non-starch polysaccharides. A person of ordinary skill in the art will appreciate that there are a variety of commercially available non-starch polysaccharide hydrolyzing enzymes that may be used. The hemicellulase blend may be added to the slurry at a concentration of up to 1.0 kg/MT and preferably between about 0.02 kg/MT and 0.2 kg/MT.

The slurry is then heated at a temperature of between about 60° C. and 67° C. and in some embodiments about 65° C. The heating may be continued for between about 30 minutes and 120 minutes and in some embodiments about 60 minutes. The slurry may be further treated to a higher temperature of between about 75° C. and 105° C. and in some embodiments at a temperature of about 85° C. to solubilize more starch while controlling final mash viscosity for use in fermentation.

Thereafter, the mash was cooled to a temperature of less than about 40° C. and in some embodiments about 32° C. At this time, the pH of the mash may be adjusted to less than 5.0 and in certain embodiments between about 4.0 and 4.8 using dilute sulfuric acid.

It is also possible to add a nitrogen source. One such suitable nitrogen source is urea that is provided at a concentration of up to about 600 ppm and in certain embodiments about 400 ppm.

A saccharifying enzyme such as glucoamylase may be added to the mash at a concentration of between about 0.1 and 1.5 kg/MT and in some embodiments about 0.5 kg/MT. A person of ordinary skill in the art will appreciate that there are a variety of commercially available glucoamylases that may be used.

Additionally, it is possible to add a protease at a concentration of between about 0.01 and 1.0 kg/MT and in some embodiments about 0.08 kg/MT. A person of ordinary skill in the art will appreciate that there are a variety of commercially available proteases that may be used.

The fermentation mixture was then inoculated with dry active yeast at a concentration of between 0.02 and 1.0 percent and in some embodiments about 0.06 percent. During fermentation the temperature was maintained at about 32° C. until it appeared that fermentation was substantially completed. In one configuration, fermentation was conducted for about 65 hours. The process thereby enabled the production of ethanol with the DDGS having desirable starch and protein levels.

The concepts of the invention are disclosed with reference to the following examples. These examples are not intended to limit the scope of the invention.

### EXAMPLE 1

As a preliminary step, Vista white wheat flour was ground through a #8 screen using a hammer mill. A slurry was prepared by mixing together approximately 640 grams of the Vista white wheat flour with about 1,360 grams of water, alpha-amylase at a concentration of about 0.2 kg/MT of flour, and hemicellulase at a concentration of about 0.2 kg/MT of flour.

A comparative slurry was prepared using the same compositions set forth above with the exception of alpha-amylase, which was omitted.

The pH of the slurry was adjusted to about 5.5 using dilute sulfuric acid. While stirring, the slurry was then heated to a temperature of about 60° C. Samples were periodically taken for HPLC analysis, refractive index measurement and viscosity measurement. The refractive index was measured using the brix scale. The viscosity was measured using a Brookfield viscometer.

Results are set forth in Table 1. The slurry processed with a viscosity breaking enzyme (NSP hydrolyzing enzyme) identified as HC while the slurry processed with an NSP hydrolyzing enzyme and alpha-amylase is identified as “HC+AA.”

TABLE 1
Pretreating 32% wheat at pH 5.5 and 60° C.

| | | HPLC % W/V | | | | | | Calculated |
|---|---|---|---|---|---|---|---|---|
| Enzyme | Hour | DP > 3 | DP3 | Malt | Glucose | Brix | Viscosity | DE |
| HC | 0.5 | 2.71 | 0.19 | 1.92 | 0.75 | 6.6 | 220 | 2.4 |
| HC | 1 | 3.12 | 0.23 | 2.28 | 0.78 | 7.6 | 224 | 2.7 |
| HC | 2 | 3.68 | 0.29 | 2.68 | 0.83 | 8.7 | 236 | 3.1 |
| HC | 4 | 4.17 | 0.38 | 3.05 | 0.88 | 9.8 | 276 | 3.5 |
| HC | 7 | 4.60 | 0.48 | 3.32 | 0.95 | 10.8 | 392 | 3.8 |
| HC | 24 | 6.01 | 0.79 | 3.98 | 1.21 | 13.9 | 2075 | 4.8 |
| HC + AA | 0.5 | 4.97 | 0.99 | 6.67 | 0.93 | 13.3 | 92 | 6.1 |
| HC + AA | 1 | 5.41 | 1.15 | 7.88 | 1.00 | 14.7 | 100 | 7.0 |
| HC + AA | 2 | 5.74 | 1.34 | 8.98 | 1.00 | 16.6 | 104 | 7.8 |
| HC + AA | 4 | 5.83 | 1.57 | 10.04 | 1.06 | 17.9 | 144 | 8.6 |
| HC + AA | 7 | 5.81 | 1.83 | 11.04 | 1.13 | 19.4 | 164 | 9.3 |
| HC + AA | 24 | 5.42 | 2.88 | 14.31 | 1.49 | 24.2 | 244 | 12.0 |

The HPLC profile shows that not much maltose is formed during the incubation with only hemicellulase, but when the alpha-amylase was added over 3.5 times more maltose was produced. This observation was surprising because alpha-amylase does not produce maltose, but a significant amount of maltose was formed that indicates the action of endogenous beta-amylase in wheat.

The increase in starch hydrolysis by both added enzymes is also shown by the increase in the refractive index and the increased DE.

The alpha-amylase does not hydrolyze non-starch polysaccharides, but the viscosity is substantially less when the alpha-amylase is present. It is envisioned that the large increase in the viscosity of the hemicellulase-treated slurry at 24 hours is caused by some high molecular weight starch being solubilized that is not being hydrolyzed by the endogenous wheat beta-amylase.

This observation is supported by the fact that the beta-amylases are exo-acting enzymes that hydrolyze maltose units from dextrin from the non-reducing end. When a branch point is encountered in the dextrin, beta-amylase action is stopped.

The alpha-amylase is an endo-active enzyme, which means that it hydrolyzes the starch within the starch molecule. Alpha-amylase cannot hydrolyze branch linkages either, but since it hydrolyzes the starch within the structure, the branch points do not stop the enzyme action as was the case for beta-amylase.

With the presence of alpha-amylase, more non-reducing ends of dextrin are formed, which allows beta-amylase to produce more maltose. As maltose is a very good fermentable sugar, forming the maltose is desirable for ethanol fermentation mash.

### EXAMPLE 2

The influence of hemicelluase in reducing the slurry viscosity was evaluated using ground whole wheat and ground wheat endosperm. As an initial step, soft white winter wheat was fractionated into 15.6 percent bran and 84.4 percent endosperm. A slurry was prepared by mixing together approximately 640 grams of the ground whole wheat or the ground wheat endosperm with about 1,360 grams of water, alpha-amylase at a concentration of about 0.2 kg/MT. The hemicellulase was added at concentrations of 0, 0.1 and 0.3 kg/MT.

The pH of the slurry was adjusted to about 5.5 using dilute sulfuric acid. While stirring, the slurry was then heated to a temperature of about 60° C. for about 30 minutes and then treated at a temperature of about 85° C. for about 90 minutes to complete liquefaction. Results are set forth in Table 2.

TABLE 2
Liquefaction of whole wheat and wheat endosperm

| | Pretreat | | Liq | | | HPLC Carbohydrate | | | |
|---|---|---|---|---|---|---|---|---|---|
| | 0.5 hr | HC | 1.5 hr | | | Profile % w/v | | | |
| Wheat | ° C. | kg/MT | ° C. | Brix | Vis cp | DP4+ | DP3 | DP2 | Glucose |
| Whole | 60 | 0.00 | 85 | 26.3 | 680 | 14.55 | 2.34 | 13.59 | 1.11 |
| Whole | 60 | 0.10 | 85 | 26.3 | 220 | 14.73 | 2.34 | 13.27 | 1.12 |
| Whole | 60 | 0.30 | 85 | 26.7 | 196 | 14.53 | 2.46 | 13.28 | 1.10 |
| Endosperm | 60 | 0.00 | 85 | 26.5 | 636 | 13.40 | 2.26 | 14.53 | 0.96 |
| Endosperm | 60 | 0.10 | 85 | 26.9 | 328 | 14.09 | 2.37 | 14.22 | 0.99 |
| Endosperm | 60 | 0.30 | 85 | 26.8 | 130 | 14.33 | 2.40 | 13.90 | 0.95 |

The results indicate that the viscosity of the liquefact is related to the level of hemicellulase. These results also show that even with fractionated wheat, viscosity issues are still a problem. These results are expected because the non-starch polysaccharides are located in the wheat endosperm as well.

These results also show that the hemicellulase does not contribute to starch liquefaction, and does not contribute to the synergistic activity of the alpha-amylase and beta-amylase in forming maltose. The primary benefit of the hemicellulase was the reduction of viscosity.

### EXAMPLE 3

The performance of CPS red Canadian wheat was also evaluated. As a preliminary step, CPS red Canadian wheat was ground through a #7 screen using a Bliss hammer mill. In a fermentation vessel having a capacity of about 180 liters, approximately 91.8 liters of water was added and then heated to a temperature of about 60° C. While stirring, about 43.2 kg of ground CPS red Canadian wheat was added to the fermentation vessel.

After about 40 percent of the flour was added, hemicellulase was added at a concentration of about 0.2 kg/MT and alpha-amylase was added at a concentration of about 0.2 kg/MT. The pH of the slurry was adjusted to about 5.5 with the addition of 50% (v/v) sulfuric acid. The slurry was maintained at a temperature of about 60° C. and then heated to a temperature of about 85° C. to complete the liquefaction step.

After the one hour pretreatment, a viscosity of the slurry was measured. The brix of the supernatant was also measured. The supernatant was also analyzed using HPLC. The results are reported in Table 3. The results show that as the temperature of the pretreatment increased, the mash viscosity also increased, and more starch was liquefied as indicated by the increase in the brix. The HPLC results show that the wheat beta-amylase was active up to about 65° C. as seen by the high maltose level.

TABLE 3

| | | | | | | | | |
|---|---|---|---|---|---|---|---|---|
| | | Time | Viscosity | | % w/v | % w/v | % w/v | % w/v |
| Trial | Temp ° C. | (min) | (cp) | RI (Brix) | DP > 3 | DP3 | DP2 | DP1 |

Pretreatment of 32% (as is solids) at pH 5.5 with 0.2 kg/MT AA + 0.2 kg/MT HC

| | | | | | | | | |
|---|---|---|---|---|---|---|---|---|
| 1 | 60 | 60 | 182 | 20.6 | 7.90 | 1.48 | 12.32 | 0.79 |
| 2 | 65 | 60 | 342 | 22.2 | 9.25 | 1.58 | 12.90 | 0.70 |
| 3 | 70 | 60 | 364 | 23.3 | NA | NA | NA | NA |

Liquefaction results

| | | | | | | | | |
|---|---|---|---|---|---|---|---|---|
| 1 | 85 | 90 | 155 | 24.7 | 13.14 | 2.23 | 11.96 | 1.07 |
| 2 | 85 | 90 | 228 | 25.0 | 12.62 | 2.10 | 12.58 | 0.87 |
| 3 | 85 | 90 | 243 | 25.6 | 21.03 | 2.00 | 5.71 | 0.89 |

Fermentation 32° C. with 0.5 kg/MT GA + 0.08 kg/MT Prot

| | | | | | | % W/V | | % W/V | | | |
|---|---|---|---|---|---|---|---|---|---|---|---|
| | | % W/V | % W/V | % W/V | % W/V | Lactic | % W/V | Acetic | % V/V | DDGS % | DDGS % |
| Trial | Hours | DP > 3 | DP3 | DP2 | DP1 | Acid | Glycerol | Acid | Ethanol | Starch | Protein |
| 1 | 65.5 | 1.68 | 0.13 | 0.17 | 0.24 | 0.08 | 1.09 | 0.04 | 14.61 | 1.97 | 40.30 |
| 2 | 68.0 | 2.02 | 0.01 | 0.14 | 0.04 | 0.07 | 1.00 | 0.04 | 14.41 | 2.13 | 35.35 |
| 3 | 69.5 | 1.78 | 0.01 | 0.11 | 0.10 | 0.07 | 1.10 | 0.06 | 14.87 | 2.07 | 40.13 |

After about 1.5 hours at 85° C., the liquefact was evaluated for viscosity, brix and HPLC. The results are reported in Table 3. The HPLC profile at liquefaction at 70° C. shows less maltose was formed during the pretreatment step. The lower maltose level in the 70° C. pretreated mash suggests that the endogenous wheat beta-amylase was inactivated. The higher viscosity of Trial 3 may at least in part be related to inactivation of the hemicellulase.

The slurry was then cooled to a temperature of about 32° C. The pH of the mash was adjusted to about 4.8 with sulfuric acid, and urea was added to a level of about 400 ppm. Glucoamylase was then added to the mash at a concentration of about 0.5 kg/MT and a protease was added at a concentration of about 0.08 kg/MT.

The mash was then inoculated with dry active yeast at a concentration of about 0.06 percent. During fermentation, the temperature was maintained at about 32° C. At about 65 hours, the fermentation appeared to be substantially complete and the process was terminated.

The ethanol levels after fermentation are comparable and the starch content of the DDGS is also similar. The protein level of the DDGS for Trials 1 and 3 are very similar, while the protein level of the trial DDGS is lower. The lower DDGS protein level for Trial 2 would seem to be experimental error. When viewed together, these results would indicate that pretreatment temperature should not exceed 65° C.

### EXAMPLE 4

The process set forth in Example 3 was repeated using CPS Vista white wheat. One other difference is that the temperatures used in the pretreatment were 55° C., 60° C. and 65° C. The results are reported in Table 4.

TABLE 4

| | | | | | | | | |
|---|---|---|---|---|---|---|---|---|
| | | Time | Viscosity | | % w/v | % w/v | % w/v | % w/v |
| Trial | Temp ° C. | (min) | (cp) | RI (Brix) | DP > 3 | DP3 | DP2 | DP1 |

Pretreatment of 32% (as is solids) at pH 5.5 with 0.2 kg/MT AA + 0.2 kg/MT HC

| | | | | | | | | |
|---|---|---|---|---|---|---|---|---|
| 4 | 55 | 60 | 74 | 9.6 | 4.14 | 0.65 | 4.21 | 0.85 |
| 5 | 60 | 60 | 310 | 16.7 | 6.88 | 1.21 | 9.32 | 0.72 |
| 6 | 65 | 60 | 477 | 22.0 | 8.80 | 1.78 | 12.07 | 0.69 |

Liquefaction results

| | | | | | | | | |
|---|---|---|---|---|---|---|---|---|
| 4 | 85 | 90 | 225 | 23.9 | 16.29 | 2.42 | 9.09 | 1.10 |
| 5 | 85 | 90 | 490 | 26.0 | 18.06 | 2.73 | 9.56 | 0.92 |
| 6 | 85 | 90 | 363 | 26.2 | 14.00 | 2.57 | 11.74 | 0.86 |

Fermentation 32° C. with 0.5 kg/MT GA + 0.08 kg/MT Prot

| | | | | | | % W/V | | % W/V | | | |
|---|---|---|---|---|---|---|---|---|---|---|---|
| | | % W/V | % W/V | % W/V | % W/V | Lactic | % W/V | Acetic | % V/V | DDGS % | DDGS % |
| Trial | Hours | DP > 3 | DP3 | DP2 | DP1 | Acid | Glycerol | Acid | Ethanol | Starch | Protein |
| 4 | 68.3 | 1.88 | 0.12 | 0.20 | 0.09 | 0.11 | 0.99 | 0.04 | 14.73 | 2.27 | 38.63 |
| 5 | 68.0 | 2.13 | 0.16 | 0.23 | 0.11 | 0.08 | 1.12 | 0.04 | 15.40 | 1.93 | 37.46 |
| 6 | 68.0 | 1.97 | 0.10 | 0.13 | 0.05 | 0.07 | 1.11 | 0.06 | 15.20 | 2.10 | 38.99 |

Pretreatment below 65° C. shows less starch being liquefied as evidenced by the mash brix decreasing as the temperature decreased. Additionally, at pretreatment temperatures below 65° C. less maltose was formed, which indicates that the enzymatic hydrolysis by alpha-amylase and wheat beta-amylase were not as active. The increase in the mash viscosity as the pretreatment temperature increased may reflect the increase in the amount of starch liquefied.

During liquefaction, more starch was liquefied for all the mashes except the mash pretreated at a temperature of about 55° C., which resulted in a substantial decrease in liquefied starch, as evidenced by the brix of 23.9 versus brix values of 26 for the mashes pretreated at 60° C. and 65° C. There is no clear reason why the viscosity of the mash pretreated at 60° C. increased when liquefied, although the higher sugars in the liquefact are higher, which may contribute to the higher viscosity.

The HPLC results after fermenting the mashes show that the ethanol yield was less for the 55° C. pretreated mash, which results in the higher DDGS starch value. The protein levels in the DDGS samples were viewed as being similar. In terms of processing, the 65° C. pretreatment seems to be optimal.

### EXAMPLE 5

The process set forth in Example 3 was repeated using whole ground wheat. Each of the slurries was pretreated at 65° C. for about 60 minutes. The slurries were then liquefied at the temperatures set forth in Table 5. After liquefaction, the mashes were fermented as described in Example 3, except that saccharifying enzyme was added at a concentration of about 0.625 kg/MT.

TABLE 5
Pretreatment of 32% (as is solids) at pH 5.5 with 0.2 kg/MT AA + 0.2 kg/MT HC

| | | Time | Viscosity | | % w/v | % w/v | % w/v | % w/v |
|---|---|---|---|---|---|---|---|---|
| Trial | Temp ° C. | (min) | (cp) | RI (Brix) | DP > 3 | DP3 | DP2 | DP1 |
| 7 | 65 | 60 | 469 | 22.7 | 9.80 | 2.52 | 12.78 | 0.20 |
| 8 | 65 | 60 | 484 | 22.0 | 8.94 | 1.69 | 12.57 | 0.70 |
| 9 | 65 | 60 | 476 | 22.6 | 8.90 | 1.67 | 12.59 | 0.70 |
| 10 | 65 | 60 | 464 | 21.7 | 8.53 | 1.64 | 12.27 | 0.69 |
| 11 | 65 | 60 | 477 | 22.0 | 8.80 | 1.78 | 12.07 | 0.69 |
| 12 | 65 | 60 | 571 | 22.8 | 9.67 | 2.26 | 12.28 | 0.70 |
| 13 | 65 | 60 | 441 | 22.0 | 9.10 | 2.03 | 12.43 | 0.68 |

Liquefaction results

| | | | Viscosity | Viscosity | | | | | |
|---|---|---|---|---|---|---|---|---|---|
| | | Time | @ Liq | @ 32° C. | | % w/v | % w/v | % w/v | % w/v |
| Trial | Temp ° C. | (min) | Temp (cp) | (cp) | RI (Brix) | DP > 3 | DP3 | DP2 | DP1 |
| 7 | 65 | 90 | 451 | 831 | 23.0 | 9.67 | 2.27 | 13.21 | 0.25 |
| 8 | 70 | 90 | 504 | 1592 | 24.6 | 12.17 | 2.20 | 12.29 | 0.76 |
| 9 | 75 | 90 | 456 | 1538 | 26.2 | 13.41 | 2.29 | 12.43 | 0.85 |
| 10 | 80 | 90 | 394 | 683 | 25.4 | 13.48 | 2.30 | 12.01 | 0.86 |
| 11 | 85 | 90 | 363 | 666 | 26.2 | 14.00 | 2.57 | 11.74 | 0.86 |
| 12 | 90 | 90 | 348 | 773 | 27.0 | 15.40 | 3.07 | 12.37 | 0.84 |
| 13 | 95 | 90 | 279 | 592 | 26.4 | 15.18 | 2.83 | 11.88 | 0.83 |

Fermentation 32° C. with 0.625 kg/MT GA + 0.08 kg/MT Prot

| | | | | | | % W/V | | % W/V | | | |
|---|---|---|---|---|---|---|---|---|---|---|---|
| | | % W/V | % W/V | % W/V | % W/V | Lactic | % W/V | Acetic | % V/V | DDGS % | DDGS % |
| Trial | Hours | DP > 3 | DP3 | DP2 | DP1 | Acid | Glycerol | Acid | Ethanol | Starch | Protein |
| 7 | 68.8 | 1.87 | 0.14 | 0.11 | 0.10 | 0.08 | 0.98 | 0.05 | 14.79 | 3.77 | 38.47 |
| 8 | 68.3 | 2.17 | 0.03 | 0.10 | 0.08 | 0.07 | 1.03 | 0.05 | 14.93 | 2.30 | 36.58 |
| 9 | 69.0 | 1.91 | 0.11 | 0.12 | 0.05 | 0.07 | 1.10 | 0.04 | 15.20 | 2.70 | 39.02 |
| 10 | 65.3 | 1.93 | 0.11 | 0.14 | 0.05 | 0.06 | 1.07 | 0.04 | 14.81 | 2.03 | 38.88 |
| 11 | 68.0 | 1.97 | 0.10 | 0.13 | 0.05 | 0.07 | 1.11 | 0.06 | 15.20 | 2.10 | 38.99 |
| 12 | 69.3 | 2.06 | 0.15 | 0.23 | 0.11 | 0.07 | 1.10 | 0.03 | 15.66 | 2.60 | 39.31 |
| 13 | 69.5 | 2.09 | 0.15 | 0.21 | 0.05 | 0.07 | 0.87 | 0.03 | 15.03 | 2.00 | 38.19 |

Because the pretreatment conditions were the same, it was not surprising that each of the slurries exhibited similar analytical results after pretreatment. Two viscosities were measured to determine the difference in the viscosity at the liquefaction temperature and then at the cooled temperature.

The viscosities at the liquefaction temperature show a trend of decreasing as the liquefaction temperature increased. The viscosities of the cooled mashes (32° C.) vary significantly. The viscosities increased substantially up to liquefaction temperature of about 75° C. At temperatures above 75° C., the viscosities abruptly decrease by about 50%.

It is envisioned that this abrupt viscosity decrease relates to factors other than starch derived species because the amount of starch solubilized and the HPLC profiles of the mashes are very similar. There could have been structural changes in the protein, in the non-starch polysaccharides or some other type of interaction.

As the liquefaction temperature increased, the amount of starch solubilized increased as seen by the brix that trends upward. Also, the carbohydrate profile of the liquefied mashes shows an increase in the higher sugar fraction (DP>3) indicating more starch being liquefied.

The fermentation results show at the lower liquefaction temperature (65° C., Trial 7), the ethanol yield was lower and had a little more starch in the DDGS. The protein values of the DDGS are relatively similar. When viewed together, the results indicate that there is a broad optimal liquefaction temperature range of between about 80° C. and 95° C.

### EXAMPLE 6

The process set forth in Example 3 was repeated using whole ground wheat. Each of the slurries was pretreated at 65° C. for about 60 minutes and then liquefied at a temperature of about 85° C. for the times set forth in Table 6. After liquefaction, the mashes were cooled and then fermented as described in Example 3.

TABLE 6
Pretreatment of 32% (as is solids) at pH 5.5 with 0.2 kg/MT AA + 0.2 kg/MT HC

| | | Time | Viscosity | | % w/v | % w/v | % w/v | % w/v |
|---|---|---|---|---|---|---|---|---|
| Trial | Temp ° C. | (min) | (cp) | RI (Brix) | DP > 3 | DP3 | DP2 | DP1 |
| 14 | 65 | 60 | 484 | 22.6 | 10.0 | 1.89 | 12.75 | 0.68 |
| 15 | 65 | 60 | 443 | 21.9 | 9.39 | 1.78 | 12.47 | 0.67 |
| 16 | 65 | 60 | 477 | 22.0 | 8.80 | 1.78 | 12.07 | 0.69 |
| 17 | 65 | 60 | 502 | 22.9 | 9.84 | 2.19 | 12.91 | 0.72 |

Liquefaction results

| | | | Viscosity | Viscosity | | | | | |
|---|---|---|---|---|---|---|---|---|---|
| | | Time | @ Liq | @ 32° C. | | % w/v | % w/v | % w/v | % w/v |
| Trial | Temp ° C. | (min) | Temp (cp) | (cp) | RI (Brix) | DP > 3 | DP3 | DP2 | DP1 |
| 14 | 85 | 30 | 368 | 689 | 26.0 | 14.12 | 2.48 | 12.53 | 0.75 |
| 15 | 85 | 60 | 320 | 633 | 25.7 | 14.32 | 2.62 | 12.14 | 0.80 |
| 16 | 85 | 90 | 363 | 666 | 26.2 | 14.00 | 2.57 | 11.74 | 0.86 |
| 17 | 85 | 120 | 353 | 648 | 27.0 | 14.86 | 3.06 | 12.60 | 0.93 |

Fermentation 32° C. with 0.625 kg/MT GA + 0.08 kg/MT Prot

| | | | | | | % W/V | | % W/V | | | |
|---|---|---|---|---|---|---|---|---|---|---|---|
| | | % W/V | % W/V | % W/V | % W/V | Lactic | % W/V | Acetic | % V/V | DDGS % | DDGS % |
| Trial | Hours | DP > 3 | DP3 | DP2 | DP1 | Acid | Glycerol | Acid | Ethanol | Starch | Protein |
| 14 | 67.5 | 1.82 | 0.17 | 0.13 | 0.11 | 0.07 | 1.12 | 0.03 | 15.36 | 2.23 | 38.61 |
| 15 | 69.2 | 1.98 | 0.15 | 0.19 | 0.11 | 0.07 | 1.08 | 0.03 | 14.99 | 2.07 | 38.27 |
| 16 | 68.0 | 1.97 | 0.10 | 0.13 | 0.05 | 0.07 | 1.11 | 0.06 | 15.20 | 2.10 | 38.99 |
| 17 | 69.5 | 1.97 | 0.17 | 0.23 | 0.11 | 0.07 | 1.11 | 0.03 | 15.32 | 2.10 | 37.07 |

The results after liquefaction show that there was little difference in any of the analytical parameters of the liquefacts. The fermentation results also indicate that extending liquefaction longer than 30 minutes did not improve ethanol yield.

### EXAMPLE 7

The process set forth in Example 3 was repeated using whole ground wheat to prepare two slurries. A first slurry (Trial 18) was pretreated at 65° C. for about 60 minutes and then liquefied at a temperature of about 85° C. for about 90 minutes. The liquefact was cooled to a temperature of about 32° C. and then fermented as described in Example 3.

A second slurry (Trial 19) was pretreated at a temperature of about 65° C., except that only about 50% of the alpha-amylase was added. The slurry was then heated to a temperature of about 105° C. and held at this temperature for about 5 minutes. Thereafter, the slurry was cooled to a temperature of about 85° C., and the remaining 50% of the alpha-amylase was added. The liquefact was maintained at a temperature of about 85° C. for about 90 minutes. The liquefact was cooled and fermented similar to Trial 18. The results of Trials 18 and 19 are reported in Table 7.

TABLE7
Pretreatment of 32% (as is solids) at pH 5.5 with 0.2 kg/MT AA + 0.2 kg/MT HC

| | | Time | Viscosity | | % w/v | % w/v | % w/v | % w/v |
|---|---|---|---|---|---|---|---|---|
| Trial | Temp ° C. | (min) | (cp) | RI (Brix) | DP > 3 | DP3 | DP2 | DP1 |
| 18 | 65 | 60 | 477 | 22.0 | 8.80 | 1.78 | 12.07 | 0.69 |
| 19 | 65 | 60 | 565 | 21.9 | 9.69 | 1.39 | 12.56 | 0.66 |

| | |
|---|---|
| 19 | Cooked at 105 C. for 5 minutes |

Liquefaction results

| | | | Viscosity | Viscosity | | | | | |
|---|---|---|---|---|---|---|---|---|---|
| | | Time | @ Liq | @ 32° C. | | % w/v | % w/v | % w/v | % w/v |
| Trial | Temp ° C. | (min) | Temp (cp) | (cp) | RI (Brix) | DP > 3 | DP3 | DP2 | DP1 |
| 18 | 85 | 90 | 363 | 666 | 26.2 | 14.00 | 2.57 | 11.74 | 0.86 |
| 19 | 85 | 90 | 330 | 673 | 26.4 | 15.63 | 2.24 | 11.94 | 0.82 |

Fermentation 32° C. with 0.625 kg/MT GA + 0.08 kg/MT Prot

| | | | | | | % W/V | | % W/V | | | |
|---|---|---|---|---|---|---|---|---|---|---|---|
| | | % W/V | % W/V | % W/V | % W/V | Lactic | % W/V | Acetic | % V/V | DDGS % | DDGS % |
| Trial | Hours | DP > 3 | DP3 | DP2 | DP1 | Acid | Glycerol | Acid | Ethanol | Starch | Protein |
| 18 | 68.0 | 1.97 | 0.10 | 0.13 | 0.05 | 0.07 | 1.11 | 0.06 | 11.93 | 2.10 | 38.99 |
| 19 | 67.7 | 2.49 | 0.03 | 0.23 | 0.03 | 0.07 | 1.08 | 0.07 | 11.99 | 2.07 | 35.95 |

The 105° C. cook temperature increased the amount of starch liquefied by only a small amount from 26.2 to 26.4 brix, which was not viewed as significant. The fermentation results indicate that cooking the mash did not appreciably affect ethanol yield, or the starch level in the DDGS. The lower level of protein in the DDGS for the 105° C. cooked mash was not viewed as significant, likely resulting from experimental error.

These results indicate that cooking at a temperature of above 100° C. did not help liquefy any more starch than the liquefaction step performed at a temperature of about 85° C. In a typical commercial plant, cooking at 105° C. would normally be done by passing the slurry through a jet cooker. The results from this example show that jet cooking is not necessary.

### EXAMPLE 8

The techniques of the invention were evaluated using barley and triticale. Each grain was ground through a 2.0 mm screen using a device such as a Perten lab mill to produce a flour. Slurries were prepared by adding about 480 grams of flour to about 1,020 grams of water. This process produced slurries having a dissolved solids concentration of about 32%.

The pH of the slurry was adjusted to about 5.5 using an acid such as sulfuric acid. Alpha-amylase was added to the slurry at a concentration of about 0.2 kg/MT (as is solids). The slurries were then pretreated by heating to a temperature of about 65° C. for one hour.

During the pretreatment at about 30 and 60 minutes, a sample of the slurry was centrifuged for brix and HPLC analysis on the supernatant. The viscosities of the slurries were also measured at 60 minutes of pretreatment.

Next, the slurries were heated to a temperature of about 85° C. for about 90 minutes to allow the liquefaction to occur. During liquefaction, samples of liquefact were removed at about 30, 60 and 90 minutes. These samples were centrifuged for brix and HPLC analysis. At about 90 minutes, a sample was taken to measure the viscosity.

Additional slurries were prepared for each grain using the process set forth above and also including a viscosity reducing enzyme hemicellulase prior to heating to 65° C. In the barley slurry, the viscosity reducing enzyme was added at a concentration of about 0.5 kg/MT. In the triticale slurry, the viscosity reducing enzyme was added at a concentration of about 0.2 kg/MT.

After about 90 minutes, the liquefact was cooled to a temperature of about 32° C. and the pH of the mash was adjusted to about 4.8. To the mash, urea was added at a concentration of about 400 ppm, glucoamylase at a concentration of about 0.5 kg/MT (as is solids), and a protease at a concentration of about 0.08 kg/MT. Next, an active dry yeast was added to the mash at a concentration of about 0.1%.

Thereafter, about 100 grams of the mash were placed in 250 milliliter flask, which was sealed with a rubber stopper containing a #18 gauge needle for venting. For each mash, six fermentation flasks were setup, five flasks were monitored by weight loss and one flask was sampled for HPLC analysis during the fermentation.

After fermentation, the beer in the weight loss flasks was diluted to 275 ml. A sample of the diluted beer was then taken for HPLC analysis and the remainder of the beer was dried to obtain DDGS to be analyzed for protein and starch content.

Table 8 summarizes the protein and starch levels in each grain. In this study the hulled barley was milled, but in a commercial plant the hull would probably be removed prior to milling because the hull is so abrasive. Triticale looked quite similar to wheat relative to the outer surface of the kernels. Both grains were milled without any problems.

TABLE 8
Grain Composition

Dry Basis

| Grain | % Protein | % Starch |
|---|---|---|
| Hulled Barley | 15.09 | 57.61 |
| Triticale | 11.51 | 59.72 |

Table 9 summarizes the properties of the slurries during the liquefaction process where only alpha-amylase was used, and when both alpha-amylase and hemicellulase were used.

TABLE 9
Mash Properties

| | | | | | Viscosity | | HPLC Profile % (w/v) | | | |
|---|---|---|---|---|---|---|---|---|---|---|
| Stage | Temp ° C. | Time | Viscosity | Brix | @ 32° C. cp | DE | DP4+ | DP3 | Maltose | Glucose |

Liquefaction of Barley with 0.2 kg/MT AA

| | | | | | | | | | | |
|---|---|---|---|---|---|---|---|---|---|---|
| pretreat | 65 | 30 | 17,200 | NA | | 12.56 | 6.13 | 1.37 | 6.84 | 0.27 |
| pretreat | 65 | 60 | 15,100 | NA | | 16.91 | 6.57 | 1.61 | 6.99 | 0.29 |
| Liq | 85 | 30 | 6,800 | NA | | 21.92 | 13.95 | 2.19 | 7.67 | 0.48 |
| Liq | 85 | 60 | 4,640 | NA | 20,500 | 22.61 | 14.18 | 2.22 | 7.78 | 0.53 |

Liquefaction of Barley with 0.2 kg/MT AA + 0.5 kg/MT HC

| | | | | | | | | | | |
|---|---|---|---|---|---|---|---|---|---|---|
| pretreat | 65 | 30 | 164 | 17.0 | | 11.96 | 7.09 | 1.38 | 7.52 | 0.34 |
| pretreat | 65 | 60 | 112 | 19.0 | | 15.80 | 8.08 | 1.73 | 8.33 | 0.36 |
| Liq | 85 | 30 | 128 | 26.0 | | 20.00 | 18.45 | 2.78 | 7.96 | 0.46 |
| Liq | 85 | 60 | 104 | 26.4 | 204 | 22.23 | 18.74 | 2.94 | 8.19 | 0.53 |

Liquefaction of Triticale with 0.2 kg/MT AA

| | | | | | | | | | | |
|---|---|---|---|---|---|---|---|---|---|---|
| pretreat | 65 | 30 | 520 | 22.6 | | 20.35 | 7.94 | 2.08 | 11.24 | 0.93 |
| pretreat | 65 | 60 | 372 | 23.3 | | 23.56 | 7.74 | 2.32 | 11.80 | 1.03 |
| Liq | 85 | 30 | 600 | 27.6 | | 26.46 | 12.32 | 3.27 | 12.17 | 1.25 |
| Liq | 85 | 60 | 640 | 28.0 | 3,175 | 27.75 | 12.69 | 3.36 | 12.52 | 1.32 |

Liquefaction of Triticale with 0.2 kg/MT AA + 0.2 kg/MT HC

| | | | | | | | | | | |
|---|---|---|---|---|---|---|---|---|---|---|
| pretreat | 65 | 30 | 244 | 22.2 | | 20.88 | 8.24 | 2.15 | 10.91 | 0.88 |
| pretreat | 65 | 60 | 256 | 23.4 | | 23.92 | 7.98 | 2.44 | 11.45 | 0.96 |
| Liq | 85 | 30 | 352 | 26.8 | | 28.08 | 12.94 | 3.10 | 11.27 | 1.01 |
| Liq | 85 | 60 | 376 | 26.5 | 688 | 27.49 | 13.14 | 3.19 | 11.49 | 1.06 |

As shown in Table 9 just making 32% slurry of barley is very viscous as seen by the viscosity numbers. It was impossible to get a separation by centrifuging of the slurry to obtain a clear supernatant to measure the brix. During pretreatment and liquefaction of barley without hemicellulase, the alpha-amylase was hydrolyzing gelatinized starch and the viscosity was reduced but still was very high.

When cooled to a temperature of about 32° C., the liquefact was extremely viscous. Without the use of non-starch polysaccharide hydrolyzing enzyme, processing barley would essentially be impossible. As set forth in Table 9, the use of hemicellulase made a significant difference in viscosity during pretreatment and liquefaction. These results indicate that the hemicellulase could be used at a concentration of less than 0.5 kg/MT.

While the pretreatment and liquefaction of triticale without hemicellulase was possible, the addition of hemicellulase substantially reduced the viscosity. It is noted that at a temperature of about 85° C. the viscosity of the hemicellulase treated mash is about half the non-hemicellulase treated mash, while at a temperature of about 32° C. the non-hemicellulase mash increased in viscosity by almost five fold.

While the viscosity of the hemicellulase mash only doubled upon cooling to a temperature of about 32° C., the hemicellulase and non-hemicellulase treated barley mash give similar ratios. The use of non-starch polysaccharide hydrolyzing enzymes are really a processing aid for mashing barley and triticale, similar to what is exhibited with wheat.

Table 10 summarizes the HPLC profiles of the various components during fermentations. The HPLC profiles show that more maltose was formed in triticale mash than in barley mash, suggesting that triticale contains more beta-amylase than barley. Triticale seems to be quite similar to wheat with respect to the level of maltose formed during the mashing process; however wheat generally gave slightly more maltose.

TABLE 10
Fermentation HPLC profiles normalized at 32.33% DS

| | HC | | Normalized HPLC % W/V | | | | | | | |
|---|---|---|---|---|---|---|---|---|---|---|
| Grain | kg/MT | Hours | DP4+ | DP3 | Maltose | Glucose | Lactic | Glycerol | Acetic | Ethanol |
| Barley | 0 | 6.5 | 8.27 | 0.99 | 9.73 | 3.34 | 0.00 | 0.23 | 0.00 | 1.40 |
| Barley | 0 | 23.0 | 5.80 | 0.24 | 1.09 | 1.15 | 0.08 | 0.79 | 0.02 | 7.58 |
| Barley | 0 | 30.5 | 2.60 | 0.46 | 0.37 | 0.57 | 0.09 | 0.90 | 0.03 | 9.41 |
| Barley | 0 | 47.0 | 1.33 | 0.17 | 0.29 | 0.23 | 0.08 | 0.97 | 0.03 | 10.74 |
| Barley | 0 | 55.3 | 1.20 | 0.14 | 0.27 | 0.23 | 0.07 | 0.96 | 0.03 | 10.41 |
| Barley | 0 | 72.8 | 1.15 | 0.12 | 0.12 | 0.21 | 0.07 | 1.00 | 0.04 | 10.91 |
| Barley | 0.5 | 6.5 | 9.47 | 1.09 | 9.43 | 4.12 | 0.00 | 0.21 | 0.00 | 1.38 |
| Barley | 0.5 | 23.0 | 5.50 | 0.45 | 0.67 | 1.00 | 0.08 | 0.81 | 0.00 | 8.33 |
| Barley | 0.5 | 30.5 | 2.73 | 0.42 | 0.40 | 0.42 | 0.09 | 0.88 | 0.02 | 9.42 |
| Barley | 0.5 | 47.0 | 1.96 | 0.21 | 0.29 | 0.19 | 0.06 | 0.88 | 0.02 | 10.00 |
| Barley | 0.5 | 55.3 | 1.94 | 0.20 | 0.25 | 0.19 | 0.05 | 0.88 | 0.03 | 9.91 |
| Barley | 0.5 | 72.8 | 1.80 | 0.18 | 0.10 | 0.14 | 0.03 | 0.88 | 0.03 | 10.12 |
| Triticale | 0 | 6.5 | 7.41 | 0.97 | 11.68 | 3.03 | 0.00 | 0.26 | 0.00 | 1.71 |
| Triticale | 0 | 23.0 | 4.53 | 0.65 | 1.20 | 0.91 | 0.09 | 0.81 | 0.01 | 8.05 |
| Triticale | 0 | 30.5 | 2.38 | 0.71 | 0.53 | 0.44 | 0.09 | 0.89 | 0.02 | 9.20 |
| Triticale | 0 | 47.0 | 1.52 | 0.45 | 0.30 | 0.18 | 0.08 | 0.91 | 0.02 | 9.97 |
| Triticale | 0 | 55.3 | 1.47 | 0.41 | 0.29 | 0.16 | 0.06 | 0.92 | 0.03 | 10.10 |
| Triticale | 0 | 72.8 | 1.37 | 0.37 | 0.19 | 0.13 | 0.04 | 0.92 | 0.03 | 10.28 |
| Triticale | 0.2 | 6.5 | 8.01 | 0.95 | 11.23 | 3.31 | 0.00 | 0.24 | 0.00 | 1.65 |
| Triticale | 0.2 | 23.0 | 4.83 | 0.72 | 0.86 | 0.89 | 0.08 | 0.86 | 0.00 | 8.71 |
| Triticale | 0.2 | 30.5 | 2.57 | 0.67 | 0.52 | 0.39 | 0.09 | 0.95 | 0.02 | 9.73 |
| Triticale | 0.2 | 47.0 | 1.84 | 0.48 | 0.34 | 0.19 | 0.07 | 0.95 | 0.03 | 10.28 |
| Triticale | 0.2 | 55.3 | 1.78 | 0.45 | 0.31 | 0.17 | 0.06 | 0.96 | 0.03 | 10.53 |
| Triticale | 0.2 | 72.8 | 1.68 | 0.41 | 0.18 | 0.14 | 0.04 | 0.95 | 0.03 | 10.44 |

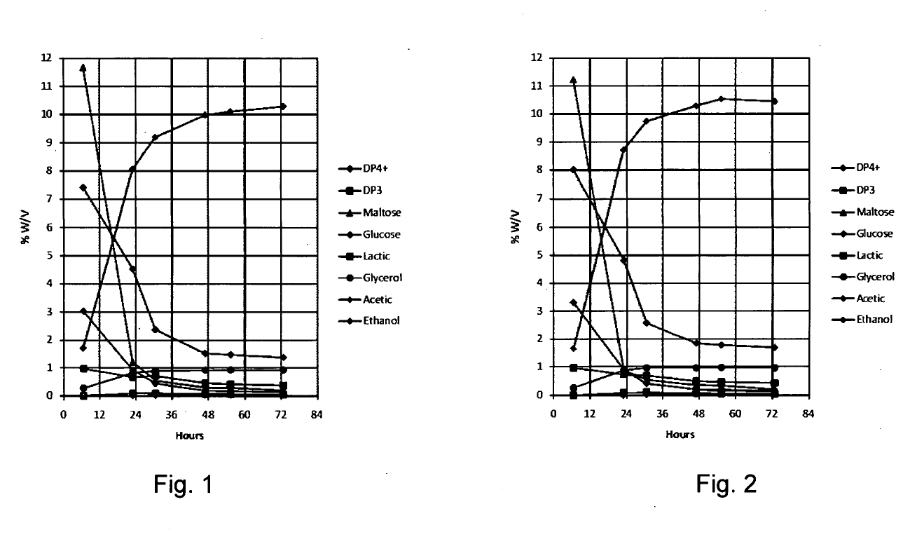

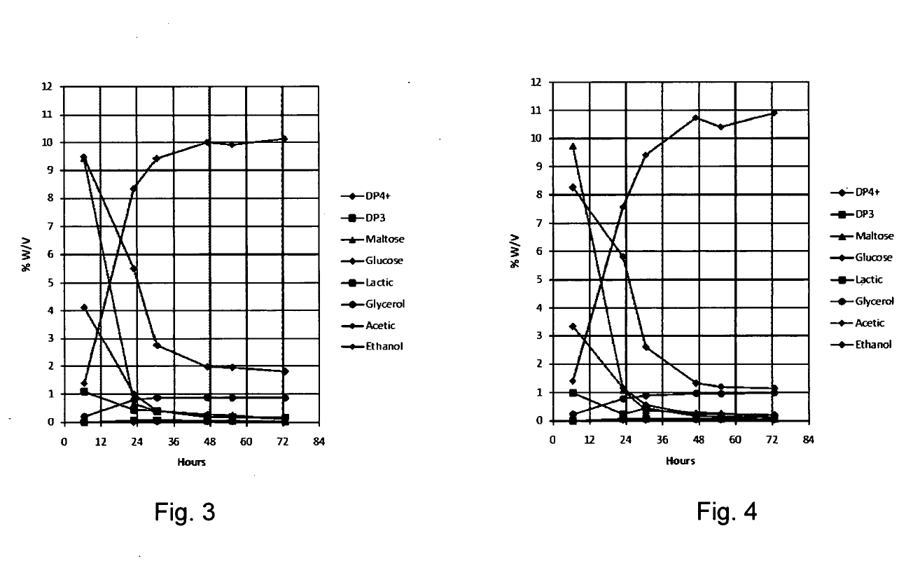

FIG. 1-4 shows the HPLC profiles of each of the fermentations. The non-hemicellulase barley mash fermentations shows more ethanol, which may result more from the higher apparent insoluble solids in the beer compared to the hemicellulase barley mash. The triticale profiles (FIGS. 3 & 4) are similar; with the hemicellulase mash fermentation showing slightly more ethanol.

The weight loss results were used to calculate the amount of ethanol using a 94% efficiency factor. An estimate of the percent weight/volume ethanol for both barley and wheat are summarized in Table 11. The results of hemicellulase in the mashing process do not seem to influence the fermentation, but certainly helps during the mashing process.

TABLE 11
Estimated % w/v ethanol from weight loss results

| | Average Normalized % w/v Ethanol | | | | | |
|---|---|---|---|---|---|---|
| Mash | 6 Hr | 22 Hr | 30 Hr | 46 Hr | 54 Hr | 70 Hr |
| Barley | 1.34 | 7.10 | 8.52 | 9.26 | 9.38 | 9.56 |
| Barley + HC | 1.19 | 7.48 | 8.66 | 9.28 | 9.42 | 9.58 |
| Titicale | 1.48 | 7.59 | 8.81 | 9.50 | 9.62 | 9.80 |
| Triticale + HC | 1.42 | 7.89 | 8.96 | 9.49 | 9.61 | 9.76 |

The weight loss results were also used to calculate the ethanol yield in terms of the gallons per bushel, which is summarized in Table 12. For barley the weight per bushel of 48 pounds was used and for triticale 50 pounds were used. The moisture content for both grains was used as about 14%.

TABLE 12
Ethanol yield from fermenter weight loss

| Mash | 6 Hr | 22 Hr | 30 Hr | 46 Hr | 54 Hr | 70 Hr |
|---|---|---|---|---|---|---|
| | Average gal ethanol/bu | | | | | |
| Barley | 0.26 | 1.38 | 1.66 | 1.81 | 1.83 | 1.86 |
| Barley + HC | 0.23 | 1.46 | 1.69 | 1.81 | 1.84 | 1.87 |
| Titicale | 0.31 | 1.60 | 1.85 | 2.00 | 2.03 | 2.06 |
| Triticale + HC | 0.30 | 1.66 | 1.89 | 2.00 | 2.02 | 2.05 |
| | Stdev gal ethanol/bu | | | | | |
| Barley | 0.01 | 0.01 | 0.01 | 0.00 | 0.01 | 0.01 |
| Barley + HC | 0.01 | 0.01 | 0.01 | 0.03 | 0.04 | 0.04 |
| Titicale | 0.01 | 0.01 | 0.01 | 0.03 | 0.03 | 0.04 |
| Triticale + HC | 0.01 | 0.00 | 0.00 | 0.00 | 0.00 | 0.00 |

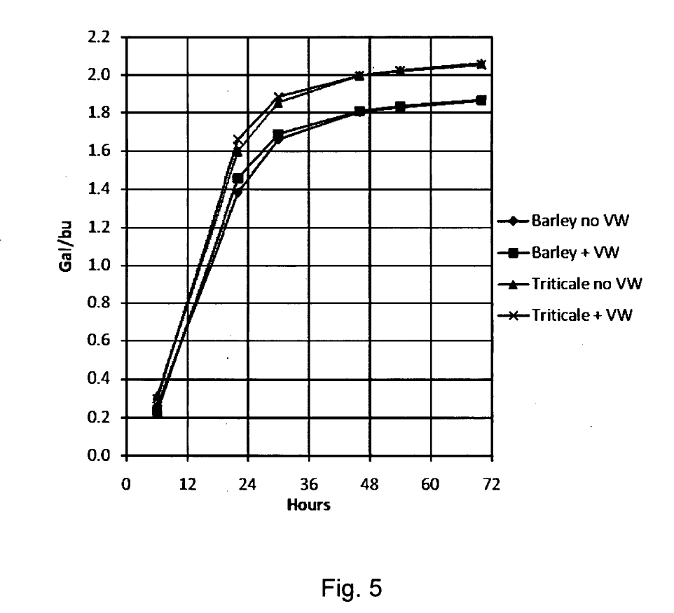

The ethanol yield as gallons per bushel for both grains is set forth in FIG. 5. These results also show that the non-starch polysaccharide hydrolyzing enzyme hemicellulase does not really help in improving ethanol yield.

After the fermentations were complete the flasks were then diluted to 250 ml prior to sampling for HPLC analysis. The summary of the results are shown in Table 13. The results with hemicellulase in the mash resulted in slightly more ethanol for each grain. Also the higher sugar fraction (DP4+) was slightly higher in the mash treated with hemicellulase for both grains. This same observation of more higher sugars in the hemicellulase mashes is shown in Table 10. These higher sugars may be solubilized non-starch polysaccharide by hemicellulase that cannot be hydrolyzed by glucoamylase.

TABLE 13
Summary of final beer HPLC analysis

| | HC | Normalized HPLC % W/V | | | | | | | |
|---|---|---|---|---|---|---|---|---|---|
| Grain | kg/MT | DP4+ | DP3 | Maltose | Glucose | Lactic | Glycerol | Acetic | Ethanol |
| Barley | 0 | 1.01 | 0.09 | 0.06 | 0.12 | 0.07 | 0.78 | 0.03 | 9.19 |
| Barley | 0.5 | 1.52 | 0.16 | 0.08 | 0.14 | 0.05 | 0.81 | 0.03 | 9.46 |
| Triticale | 0 | 1.09 | 0.32 | 0.17 | 0.14 | 0.06 | 0.85 | 0.02 | 9.74 |
| Triticale | 0.2 | 1.43 | 0.37 | 0.16 | 0.15 | 0.07 | 0.87 | 0.02 | 9.87 |

After the sample was removed from the diluted beer flasks, the remaining beer was then dried at 65° C. to obtain DDGS. The starch and protein content of the DDGS for both grains are summarized in Table 14. The starch content in the DDGS for both grains was similar to wheat. The results also show that hemicellulase treated mashed contains slightly less starch, which should translate to slightly more ethanol which would probably be hard to see in the HPLC analysis.

TABLE 14
Summary of ethanol yield and DDGS starch and protein analysis

| | Ethanol Yield | | | | | | | |
|---|---|---|---|---|---|---|---|---|
| | | | Weight | | DDGS | | DDGS | |
| | HPLC | | Loss | | Starch | | Protein | |
| Mash | GPB | Stdev | GPB | Stdev | % dsb | Stdev | % dsb | Stdev |
| Barley | 1.79 | 0.03 | 1.86 | 0.01 | 2.94 | 0.11 | 27.29 | 0.35 |
| Barley + | 1.84 | 0.03 | 1.87 | 0.04 | 2.79 | 0.19 | 27.66 | 0.40 |
| HC | | | | | | | | |
| Titicale | 2.05 | 0.02 | 2.06 | 0.04 | 2.82 | 0.42 | 35.01 | 0.36 |
| Triticale + | 2.08 | 0.01 | 2.05 | 0.00 | 2.11 | 0.12 | 35.58 | 0.10 |
| HC | | | | | | | | |

Although the HPLC results in Table 14 show a slight increase in ethanol with hemicellulase treated mash, this increase is not seen in the weight loss results. The protein level is slightly higher in the DDGS from the mash treated with hemicellulase for both grains. A close look at the HPLC ethanol results for both grains (Table 14) are significantly higher by a small margin.

The techniques of the invention were evaluated using hulled and dehulled barley were pretreated with and without a viscosity breaking enzyme, liquefied and fermented. Because of the abrasiveness of barley hulls, barley is dehulled prior to milling. One suitable device that may be utilized for dehulling the hulled barley is a Super Brix decorticator. The dehulling process causes a weight reduction of the barley of about 12.5% by weight. Table 15 shows the analysis of the various barley fractions.

TABLE 15
Barley Compositional Analysis

| | % | % DB | % DB | % DB |
|---|---|---|---|---|
| | Moisture | Starch | Protein | Fiber |
| Hulled Barley | 8.5 | 54.6 | 15.8 | 23.3 |
| Dehulled Barley^{a} | 8.8 | 61.5 | 16.5 | 27.1 |
| Barley Hulls | 6.7 | 11.1 | 11.2 | 66.3 |

^{a}During dehulling of barley 12.5% by weight was removed.

Slurries were prepared by adding about 640 grams of barley ground through a 2.0 mm screen Perten hammer mill to about 1,500 grams of water. The slurry had a solids content of about 32%. The slurry was pretreated at a temperature of about 65° C. for one hour.

During the slurry make up alpha-amylase was added to the slurry at a concentration of about 0.2 kg/MT of solids. For those samples that included a viscosity breaking enzyme (hemicellulase), the component was added at a concentration of about 0.2 kg/MT. During the slurry make-up the pH was maintained at about 5.5. Because of the nature of the slurry, very little adjustment was required.

After the pretreatment the mash was heated to a temperature of about 85° C. for a liquefaction step that lasted about 2 hours. The viscosity of the mash was periodically measured using a Brookfield Viscometer. A sample of the mash was also analyzed with an HPLC for DE assay. Also after two hours of liquefaction the viscosity was taken at 85° C. and at 32° C.

Thereafter, the pH of the mash was adjusted to about 4.5 by the addition of sulfuric acid, and urea was added at a concentration of about 400 ppm. Glucoamylase was added at a concentration of about 0.5 kg/MT solids and protease was added at a concentration of about 0.08 kg/MT. The mash was then inoculated with active dry yeast at a concentration of about 0.1%. Next, approximately 200 grams of mash were added to 500 ml Erlenmeyer flasks. Duplicate flasks were prepared for each mash.

The flasks were then sealed with a stopper containing an 18 gauge needle to vent the flask. The flasks were then placed in temperature control shaker at a temperature of about 32° C. and a frequency of about 150 rpm. Periodically during the fermentation, samples were removed for HPLC analysis.

Table 16 summarizes the influence hemicellulase has on reducing the viscosity of the mash during the pretreatment. While the dehulled barley mash had a much higher viscosity than the hulled barley mash, the hemicellulase mash resulted in a very dramatic reduction in viscosity.

TABLE 16
Barley Liquefaction

| | | | | | | | | | Final |
|---|---|---|---|---|---|---|---|---|---|
| | 1 hour, 65 degrees | | | 1 hour, | | 2 hour, 85 degrees | | | 32 degrees |
| | | | Hot viscosity | 85 degrees | | | | Hot viscosity | viscosity w/ |
| Barley Mash | Brix | DE | w/ Brookfield | Brix | DE | Brix | DE | w/ Brookfield | Brookfield |
| Hulled w/o HC | 21.8 | 19.74 | 1,410 | 24.7 | 18.53 | 24.9 | 20.38 | 570 | 5,760 |
| Hulled with HC | 21.7 | 16.73 | 290 | 25.2 | 18.78 | 26.2 | 20.79 | 140 | 1,060 |
| Dehulled w/o HC | 25.9^{b} | 16.06 | 16,000 | 28.7^{b} | 20.43 | 28.9^{b} | 22.49 | 14,400 | 30,800 |
| Dehulled with HC | 22.2 | 16.69 | 500 | 26.9 | 19.79 | 28.0 | 22.17 | 160 | 550 |

^{b}Brix was difficult to read because very cloudy sample.

The dehulled barley mash without hemicellulase at 32° C. was extremely thick and did not flow by pouring, almost like bread dough. The brix after liquefaction was higher for the dehulled mash as expected because of more starch present. It is believed that the DE values are high because of the action of the endogenous beta-amylase in barley as seen by the high maltose levels after 65° C. pretreatment (Table 17).

Table 17 summarizes the HPLC profiles of the mashes during mashing. It is believed that the very high viscosity of the dehulled mash at 65° C. may have effected sample handing during HPLC analysis.

TABLE 17
Average Mash HPLC (% W/V)

| | | | | | | | | | |
|---|---|---|---|---|---|---|---|---|---|
| Temp ° C. | Hour | DP4+ | DP3 | Maltose | Glucose | Lactic | Glycerol | Acetic | Ethanol |

Hulled Barley Mash

| | | | | | | | | | |
|---|---|---|---|---|---|---|---|---|---|
| 65 | 1 | 12.70 | 1.71 | 8.92 | 1.01 | 0.02 | 0.06 | 0.00 | 0.00 |
| 85 | 1 | 15.90 | 2.15 | 8.80 | 1.08 | 0.03 | 0.06 | 0.00 | 0.00 |
| 85 | 2 | 16.00 | 2.37 | 8.98 | 1.16 | 0.03 | 0.06 | 0.00 | 0.00 |

Hulled Barley Mash with HC

| | | | | | | | | | |
|---|---|---|---|---|---|---|---|---|---|
| 65 | 1 | 11.12 | 1.93 | 8.87 | 0.96 | 0.03 | 0.06 | 0.00 | 0.00 |
| 85 | 1 | 15.83 | 2.57 | 8.85 | 1.06 | 0.03 | 0.06 | 0.00 | 0.00 |
| 85 | 2 | 16.33 | 2.78 | 9.21 | 1.18 | 0.03 | 0.07 | 0.00 | 0.00 |

Dehulled Barley Mash

| | | | | | | | | | |
|---|---|---|---|---|---|---|---|---|---|
| 65 | 1^{a} | 19.53 | 0.00 | 12.42 | 1.19 | 0.03 | 0.08 | 0.00 | 0.00 |
| 85 | 1 | 16.60 | 2.55 | 9.78 | 1.05 | 0.01 | 0.04 | 0.00 | 0.00 |
| 85 | 2 | 11.17 | 2.07 | 6.93 | 0.81 | 0.00 | 0.03 | 0.00 | 0.00 |

Dehulled Barley Mash with HC

| | | | | | | | | | |
|---|---|---|---|---|---|---|---|---|---|
| 65 | 1 | 12.37 | 1.88 | 9.01 | 0.88 | 0.03 | 0.06 | 0.00 | 0.00 |
| 85 | 1 | 19.12 | 2.62 | 9.12 | 1.00 | 0.05 | 0.09 | 0.00 | 0.00 |
| 85 | 2 | 19.91 | 2.91 | 9.63 | 1.15 | 0.04 | 0.07 | 0.00 | 0.00 |

^{a}Had some integration issues of the chrmatogram

The average fermentation HPLC results are summarized in Table 18. The fermenters containing the dehulled barley without hemicellulase remained extremely thick throughout the fermentation. The results show that without pretreatment with hemicellulase, it would be virtually impossible to process the mash. The mashes containing hemicellulase gave higher ethanol yields.

TABLE 18
Average Fermentation HPLC Results (% W/V)

| | | | | | | | | |
|---|---|---|---|---|---|---|---|---|
| Hour | DP4+ | DP3 | Maltose | Glucose | Lactic | Glycerol | Acetic | Ethanol |

Hulled Barley Mash

| | | | | | | | | |
|---|---|---|---|---|---|---|---|---|
| 0 | 16.00 | 2.37 | 8.98 | 1.16 | 0.03 | 0.06 | 0.00 | 0.00 |
| 16.5 | 5.45 | 0.38 | 0.85 | 0.61 | 0.13 | 0.89 | 0.00 | 8.20 |
| 24.0 | 1.91 | 0.42 | 0.07 | 0.26 | 0.08 | 0.90 | 0.00 | 9.87 |
| 40.3 | 1.37 | 0.13 | 0.04 | 0.24 | 0.08 | 0.97 | 0.04 | 10.62 |
| 48.0 | 1.33 | 0.12 | 0.04 | 0.23 | 0.06 | 0.97 | 0.05 | 10.66 |
| 64.5 | 1.28 | 0.12 | 0.04 | 0.22 | 0.04 | 0.98 | 0.06 | 10.76 |

Hulled Barley Mash with HC

| | | | | | | | | |
|---|---|---|---|---|---|---|---|---|
| 0.0 | 16.33 | 2.78 | 9.21 | 1.18 | 0.03 | 0.07 | 0.00 | 0.00 |
| 16.5 | 7.10 | 0.37 | 1.36 | 0.55 | 0.09 | 0.81 | 0.00 | 7.95 |
| 24.0 | 3.15 | 0.58 | 0.12 | 0.27 | 0.07 | 0.90 | 0.00 | 9.82 |
| 40.3 | 2.04 | 0.22 | 0.05 | 0.18 | 0.09 | 0.98 | 0.03 | 10.86 |
| 48.0 | 1.95 | 0.20 | 0.06 | 0.17 | 0.07 | 0.98 | 0.04 | 10.94 |
| 64.5 | 1.88 | 0.18 | 0.06 | 0.15 | 0.04 | 0.99 | 0.05 | 11.10 |

Dehulled Barley Mash

| | | | | | | | | |
|---|---|---|---|---|---|---|---|---|
| 0.0 | 11.17 | 2.07 | 6.93 | 0.81 | 0.00 | 0.03 | 0.00 | 0.00 |
| 16.5 | 5.94 | 0.00 | 2.18 | 0.35 | 0.05 | 0.58 | 0.00 | 5.65 |
| 24^{a} | No Analysis | | | | | | | |
| 40.3 | 1.31 | 0.63 | 0.17 | 0.20 | 0.10 | 1.02 | 0.04 | 11.45 |
| 48.0 | 0.80 | 1.12 | 0.00 | 0.15 | 0.07 | 0.99 | 0.02 | 11.60 |
| 64.5^{b} | | | 0.03 | 0.22 | 0.09 | 1.03 | 0.04 | 11.85 |

Dehulled Barley Mash with HC

| | | | | | | | | |
|---|---|---|---|---|---|---|---|---|
| 0.0 | 19.91 | 2.91 | 9.63 | 1.15 | 0.04 | 0.07 | 0.00 | 0.00 |
| 16.5 | 9.36 | 0.00 | 3.44 | 0.72 | 0.09 | 0.83 | 0.00 | 7.59 |
| 24.0 | 6.46 | 0.43 | 0.58 | 0.56 | 0.10 | 0.97 | 0.02 | 9.80 |
| 40.3 | 2.27 | 0.25 | 0.11 | 0.31 | 0.11 | 1.11 | 0.04 | 12.10 |
| 48.0 | 2.04 | 0.20 | 0.12 | 0.28 | 0.09 | 1.10 | 0.04 | 12.29 |
| 64.5 | 1.90 | 0.16 | 0.09 | 0.17 | 0.06 | 1.12 | 0.05 | 12.57 |

^{a}The HPLC separations for the 24 hour sample for some reason gave very erroneous results
^{b}Had higher sugar resolution problems

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A method of preparing a low viscosity slurry comprising:
grinding a small grain to produce a flour;
mixing the flour with water to form a slurry;
mixing an alpha-amylase enzyme and a hemicellulase blend enzyme into the slurry to convert the slurry into a mash; and
mixing a saccharifying enzyme into the mash.

2. The method of claim 1, wherein the small grain is wheat, barley, rye, triticale, sweet potatoes and combinations thereof.

3. The method of claim 2, and further comprising a whole or fractionated coarse grains selected from the group consisting of grain sorghums, maize and combinations thereof.

4. The method of claim 1, wherein the slurry has a dissolved solids concentration of between about 20% and 50%.

5. The method of claim 1, and further comprising adjusting the pH of the slurry to between about 4.5 and 6.0.

6. The method of claim 1, wherein the alpha-amylase enzyme is added at a concentration of up to about 1.0 kg/MT.

7. The method of claim 1, wherein the hemicellulase blend enzyme comprises hemicellulase, xylanase, cellulase and beta-glucanse.

8. The method of claim 1, wherein the hemicellulase blend enzyme is added at a concentration of up to about 1.0 kg/MT.

9. The method of claim 1, and further comprising heating the slurry to a temperature of between about 60° C. and 67° C. for between about 30 minutes and 120 minutes.

10. The method of claim 9, and further comprising heating the slurry to a temperature of between about 75° C. and 105° C. for between about 60 minutes and 120 minutes.

11. The method of claim 9, and further comprising cooling the slurry to a temperature of less than about 40° C.

12. The method of claim 1, and further comprising adjusting a pH of the slurry to less than about 5.0.

13. The method of claim 1, and further comprising adding a nitrogen source to the slurry at a concentration of up to about 600 ppm.

14. The method of claim 1, wherein the saccharifying enzyme is added at a concentration of between about 0.1 kg/MT and 1.5 kg/MT.

15. The method of claim 1, and further comprising adding a protease to the mash.

16. The method of claim 15, wherein the protease is added at a concentration of between about 0.01 kg/MT and 1.0 kg/MT.

17. The method of claim 1, and further comprising adding yeast to the mash.

18. The method of claim 17, wherein the yeast is added at a concentration of between about 0.02 and 1.0 percent.

19. A method of preparing a low viscosity slurry comprising:
grinding a small grain to produce a flour;
mixing the flour with water to form a slurry;
adjusting the pH of the slurry to between about 5.0 and 6.0;
mixing an alpha-amylase enzyme and a hemicellulase blend enzyme into the slurry to convert the slurry into a mash;
heating the slurry to a temperature of between about 60° C. and 67° C.;
cooling the slurry to a temperature of less than about 40° C.;
adjusting a pH of the slurry to less than about 5.0;
mixing a saccharifying enzyme into the mash;
adding a protease to the mash; and
adding yeast to the mash.

20. The method of claim 19, wherein the small grain is wheat, barley, rye, triticale, sweet potatoes and combinations thereof.

21. The method of claim 20, and further comprising a whole or fractionated coarse grains selected from the group consisting of grain sorghums, maize and combinations thereof.

22. The method of claim 19, wherein the slurry has a dissolved solids concentration of between about 20% and 50%.

23. The method of claim 19, wherein the alpha-amylase enzyme is added at a concentration of up to about 1.0 kg/MT.

24. The method of claim 19, wherein the hemicellulase blend enzyme comprises hemicellulase, xylanase, cellulase and beta-glucanse.

25. The method of claim 19, wherein the hemicellulase blend enzyme is added at a concentration of up to about 1.0 kg/MT.

26. The method of claim 19, and further comprising heating the slurry to a temperature of between about 75° C. and 105° C. for between about 60 minutes and 120 minutes after heating the slurry to a temperature of between about 60° C. and 67° C.

27. The method of claim 19, and further comprising adding a nitrogen source to the slurry at a concentration of up to about 600 ppm.

28. The method of claim 19, wherein the saccharifying enzyme is added at a concentration of between about 0.1 kg/MT and 1.5 kg/MT.

29. The method of claim 19, wherein the protease is added at a concentration of between about 0.01 kg/MT and 1.0 kg/MT.

30. The method of claim 19, wherein the yeast is added at a concentration of between about 0.02 and 1.0 percent.
